(19) United States
(12) Patent Application Publication
(10) Pub. No.: US 2007/0069632 A1
(43) Pub. Date: Mar. 29, 2007

(54) Electroluminescent device and pixel device

(75) Inventor: Du-Zen Peng, Chu-Pei City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/236,110

(22) Filed: Sep. 26, 2005

(51) Int. Cl. H01J 1/62

(52) U.S. Cl. 313/501; 313/503

(57) ABSTRACT

An EL device has a transparent substrate, a regulating device and a plurality of EL components disposed over the substrate. Each EL component includes an EL pixel and a photo detector. Each of the EL pixels includes an anode layer, a light emitting layer and a cathode layer. The photo-detector is connected to the regulating device and disposed between the transparent substrate and the EL pixel, and adopted for converting a portion of a luminance of a light emitted from the EL pixel into a signal. A current to the corresponding EL pixel is regulated according to a decay of the first signal so that a combined CIE value of the lights emitting from all the EL pixels satisfies the predetermined set of CIE value.

### BACKGROUND OF THE INVENTION

1. Field of the Invention

The present invention generally relates to an electroluminescent (EL) device. More particularly, the present invention relates to an EL device and a pixel device having a steady CIE value of white light.

2. Description of Related Art

In general, a white light source or a color light source is important for a variety of electronic products such as display device of computer, television, mobile phone or portable devices. For example, the conventional flat panel display such as liquid crystal display (LCD) panel is not self-illuminant and requires a backlight module for providing a white light as a light source. Conventionally, cold cathode fluorescence lamp (CCFL) tubes are provided for the backlight module of LCD. However, the CCFL can not provided a uniform light source for the whole display area, and thus a diffuser plate is necessary for uniforming the light source.

Recently, electroluminescent (EL) device are gradually adopted for display device or light source since it is self-luminescent property and it may provide a uniform image or light source in the display area. FIG. 1 is a schematic view of a conventional white light EL device. Referring to FIG. 1, the conventional white light EL device 100 includes a glass substrate 102, an indium tin oxide (ITO) anode 104, a hole injection layer 106, a blue light emitting layer 108a, a green light emitting layer 108b and a red light emitting layer 108c, an electron transport layer 110, and a metal cathode 112. When a current 114 is applied via the ITO anode 104 and the metal cathode 112, holes from the ITO anode 104 and electrons form the metal cathode 112 are combined in the emitting layer 108a, 108b and 108c, and thus excitons are generated. Therefore, blue, green and red lights 122a, a22b and 122c are generated from emitting layer 108a, 108b and 108c respectively since the excitons may emit the corresponding color lights.

Generally, in order to achieve a white light, each luminance of the blue, green and red lights 122a, a22b and 122c should be optimized. FIG. 2 is a plot of luminance versus gray scales of color lights emitted from a conventional white light EL device. Referring to FIG. 2, the luminance of the blue, green, red lights and the combined white light versus the gray scales are represented by curve 202a, 202b, 202c and 204 respectively. Originally, the gray scale of each color lights are set along the line “gray 1.” Therefore, the luminance of the blue, green, red lights and the combined white light are Lb1, Lg1, Lr1 and Lwl respectively, wherein the curve 204 of the combined white light has a fixed CIE value (defined by Commission Internationale de l'Eclairage) defined by, for example, the ratio of Lb1, Lg1, and Lr1. However, as the working time of the white light EL device increases, the luminance efficiency of each emitting layer 108a, 108b and 108c will decay. For example, if the decay of the blue light emitting layers 108a is faster than that of the green light emitting layer 108b and a red light emitting layer 108c, Lb1 decays to Lb2. Therefore, the ratio of the luminance of the blue, green, red lights varies and then becomes the ratio of Lb2, Lg1, and Lr1 after working a period of time, and thus the CIE value of the white light may also vary with time and chromatic aberration of the white light may be generated. Therefore, it is important to maintain the CIR value of the combined white light of the white light EL component steady.

### SUMMARY OF THE INVENTION

Therefore, the present invention is relates to an EL device, wherein when a luminance of a first color light emitted form the EL device decays, a current to the EL pixels except for the EL pixel emitting the first color light is reduced according to a decay of the first signal sensed from the first color light so that a combined CIE value of the lights emitting from all the EL pixels may be steady.

In addition, the present invention relates to a pixel device, wherein when a luminance of a first color light emitted form the EL device decays, a current to the EL pixels except for the EL pixel emitting the first color light is reduced according to a decay of the first signal sensed from the first color light so that a combined CIE value of the lights emitting from all the EL pixels may be steady.

According to one embodiment of the present invention, an electroluminescent (EL) device is provided. The EL device comprises a photo detector, connected to a regulating device and converting a portion of a luminance of a light emitted from the one of a plurality of EL pixels into a signal, wherein the regulating device comprises a predetermined relationship between the signals and the luminance of the lights emitting from the EL pixels, and a predetermined set of CIE values of a white light, so as to regulating a CIE value of the light to satisfy the predetermined set of CIE values.

In one embodiment of the present invention, the EL pixels comprise a blue EL pixel, a green EL pixel and a red pixel.

In one embodiment of the present invention, the photo detector comprises a photodiode or a photo thin film transistor (TFT).

According to another embodiment of the present invention, an electroluminescent (EL) device comprises a transparent substrate; a control device; and a plurality of white EL components disposed over the substrate. Wherein, each of the white EL components comprises a white EL pixel having a color filter, an anode layer, a yellow emitting layer, a blue emitting layer and a cathode layer; and a photo detector connected to the control device and disposed between the transparent substrate and the white EL pixel. Thus, a portion of a luminance of a light emitted from the white EL pixel is converted into a signal. The control device comprises a predetermined relationship between the signals and the luminance of the lights emitting from the EL pixels, and a predetermined set of CIE values of a white light, so as to control a CIE value of the light to satisfy the predetermined set of CIE values.

According to another embodiment of the present invention, a method for regulating a CIE value of a pixel device comprises converting a luminance detected by a sensor of the pixel device into a signal. The signal is converted into a voltage factor in an control device. Then, the light emitted from the pixel device is regulated according to a comparison of the voltage factor and a predetermined setting of the control device.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a conventional white light EL device.

FIG. 2 is a plot of decay of luminance versus gray scales of color lights emitted from a conventional white light EL device.

FIG. 3A is a schematic cross-sectional view illustrating a white light EL component according to one embodiment of the present invention.

FIG. 3B is a schematic top view of white light EL component shown in FIG. 3A according to one embodiment of the present invention.

FIG. 4 is a circuit diagram of a pixel of a white light EL component according to one embodiment of the present invention.

FIG. 5 is a plot of luminance versus gray scales of color lights emitted from a white light EL component according to one embodiment of the present invention.

FIG. 6 is a schematic cross-sectional view of a photodiode type photo detector according to one embodiment of the present invention.

FIG. 7 is a schematic cross-sectional view of a photo TFT type photo detector according to one embodiment of the present invention.

FIG. 8 is a schematic top view of a backlight device according to one embodiment of the present invention.

FIG. 9 is a schematic top view of a display device according to one embodiment of the present invention.

FIG. 10 is a drawing, schematically illustrating a layout of a displaying apparatus with the regulating device, according to the embodiment of the present invention.

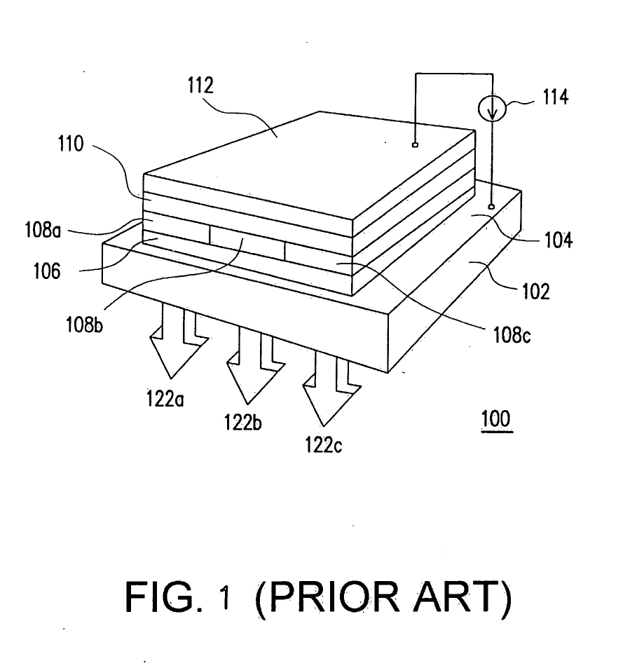

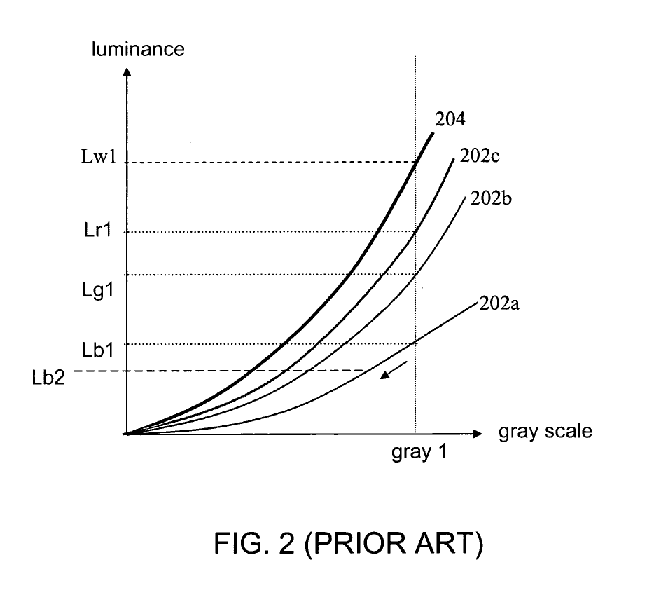

### DESCRIPTION OF EMBODIMENTS

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

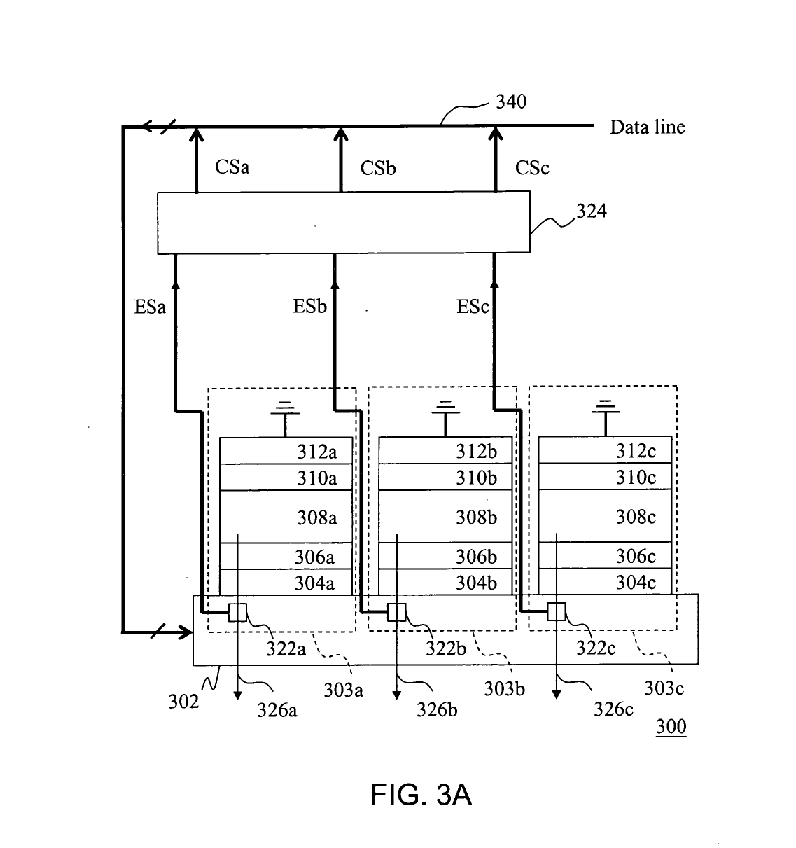

FIG. 3A is a schematic cross-sectional view illustrating a white light EL component according to one embodiment of the present invention. Referring to FIG. 3A, the white light EL component 300 may comprise a transparent substrate 302, a first EL pixel 303a including a first photo detector 322a, a second EL pixel 303b including a second photo detector 322b, a third EL pixel 303c including a third photo detector 322c, and a regulating device 324. In one embodiment of the present invention, the first, second and third EL pixels may comprise blue, green and red EL pixels. It should be noted that, in the present invention, the number of the color EL pixels are not limited to three, and the color of the EL pixels are not limited to three primary colors. In one embodiment of the present invention, the transparent substrate 302 may comprise a glass substrate.

Referring to FIG. 3A, the EL pixels 303a/303b/303c may comprise an anode layer 304a/304b/304c, a hole injection layer 306a/306b/306c, a light emitting layer 308a/308b/308c, an electron transport layer 310a/310b/310c, and a cathode layer 312a/312b/312c respectively. In one embodiment of the present invention, the anode layer 304a, 304b or 304c may comprise indium tin oxide (ITO) or indium zinc oxide (IZO), and the cathode layer 312a, 312b or 312c may comprise metal. In addition, the material of the light emitting layer 308a, 308b or 308c may comprise organic EL material or inorganic EL material. The organic EL material may comprise a small molecule organic EL material such as dye or pigment that may be formed by vacuum evaporation method, or a polymer organic EL material that may be formed by coating method.

Referring to FIG. 3A, the corresponding data signals are fed to the substrate 302 through the data line 340 for respectively driving the EL pixels 303a/303b/303c. Therefore, a first light 326a, a second light 326b and a third light 326c are generated, and a white light is achieved after the lights 326a, 326b and 326c are combined. In one embodiment of the preset invention, the lights 326a, 326b and 326c may comprise blue, green and red lights respectively.

Referring to FIG. 3A, the regulating device 324 is connected to the EL pixels 303a/303b/303c and the corresponding photo detectors 322a/322b/322c. The photo detectors 322a, 322b or 322c may be adopted for converting the lights 326a, 326b and 326c into signals ESa, ESb and ESc respectively, and the signals ESa, ESb and ESc may be received by the regulating device 324. For example, the signals ESa, ESb and ESc may directly enter the regulating device 324 or go through the data line path to enter the regulating device 324. However, it is a design choice. In one embodiment of the present invention, the signals ESa, ESb and ESc may comprise the induced current converted from the photo energy. In addition, the induced currents ESa, ESb and ESc may be converted into corresponding voltage values in the regulating device 324. In one embodiment of the present invention, the regulating device 324 may comprise an integrated circuit (IC). The regulating device 324, according to the received signals ESa, ESb and ESc, can produce proper regulating signals CSa, CSb, and CSc, so as to adjust the light into white light. The signals CSa, CSb, and CSc are then again fed to the corresponding EL color pixels through the data line 340, so as to adjust the EL pixels. Since the white light is composed of red, green, and blue lights, the adjustment can, for example, be done by actively adjusting one color pixel, such as the pixel 303a, or passively adjusting the other two color pixels of 303b and 303c. In other words, after the adjustment, the three color lights can satisfy the requirement in CIE value for white light. The adjusting mechanism is to be described later.

FIG. 3B is a schematic top view of white light EL component shown in FIG. 3A according to one embodiment of the present invention. It is noted that, the white light EL component 300 shown in FIG. 3A is a cross-sectional view along the lines AA′ shown in FIG. 3B. Referring to FIG. 3B, the EL pixels 303a/303b/303c may comprise photo detectors 322a/322b/322c and driving components 332a/332b/332c respectively. In one embodiment of the present invention, the driving components 332a/332b/332c may comprise thin film transistor (TFT). It should be noted that, the area of the photo detectors 322a/322b/322c compared to the areas of the EL pixels 303a/303b/303c is tiny, and thus the influence of the photo detectors 322a/322b/322c to the lights 326a/326b/326c is small.

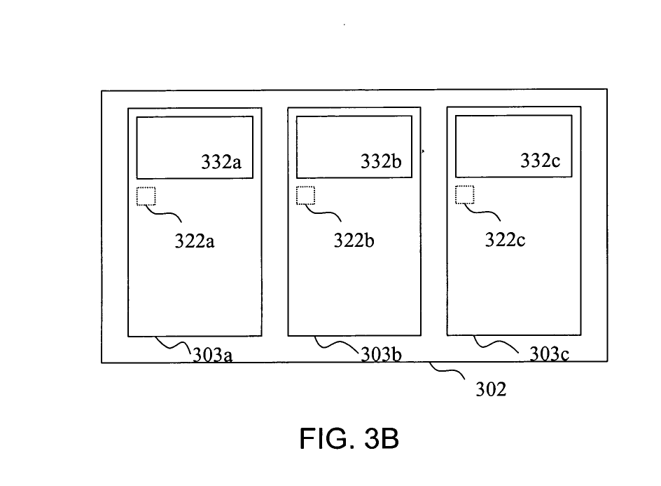

FIG. 4 is a circuit diagram of a pixel of a white light EL component according to one embodiment of the present invention. Referring to FIG. 4, the pixel circuit 400, for one color pixel as the example, may comprise an EL pixel 304a-312a (see FIG. 3A), a transistor 404, a transistor 406, a capacitor 408 and a sensor device 412. In one embodiment of the present invention, the EL pixel 304a-312a may comprise, for example, blue, green or red EL. In addition, the white light EL component of the present invention may be constructed by, for example, a blue pixel, a green pixel and a red pixel, wherein the blue pixel, green pixel and red pixel may comprise the pixel circuit 400. Moreover, the number of the color pixels of the white light EL component are not limited to three, and the color of the EL pixel 304a-312a are not limited to three primary colors. The transistor 404 may be adopted for turning on or off the current from the power to the EL pixel 304a-312a, and the transistor 406 may be adopted for turning on or off the transistor 404 under the regulating of the data line and the data scan line. The capacitor 408 may be adopted for regulating the current from the power to the EL pixel 304a-312a.

Referring to FIG. 4, FIG. 4 just shows one color pixel in FIG. 3A as the example. The sensor device 412 may comprise, for example, a transistor 414 and a photo detector 322a. The photo detector 322a may be adopted for sensing the luminance of light 326a emitted from the EL 304a-312a and transferring the luminance into a signal ESa, wherein the signal ESa may be a voltage signal or a current signal, and the amplitude of the signal ESa is proportional to the luminance. About the regulating mechanism as shown in FIG. 4 and FIG. 3A, the optical signal 326a emitted from the light emitting layer 308a is sensed by the photo detector 322a, and the signal ESa is produced. The signal ESa can, for example, go through the transistor 414 and enter the regulating device 324, as indicated by the path 440. The transistor 414 is controlled by a clock signal through the sense scan line 444 to turn on/off the transistor 414 at the proper time, so as to transmit the signal ESa. After the regulating device 324 produces the proper regulating signal, such as CSa, then the regulating signal is fed to the corresponding color pixel through the data line 340, as indicated by the path 442, so as to regulate the corresponding color pixel.

In one embodiment of the present invention, the EL pixel 304a-312a may comprise the EL pixel 303a, 303b, or 303c shown in FIG. 3A. In addition, the photo detector 322a may comprise the photo detector 322a, 322b or 322c, and the light 326a may comprise the light 326a, 326b or 326c. Hereinafter, for example, the EL pixel 303a/303b/303c may represent blue/green/red EL pixel.

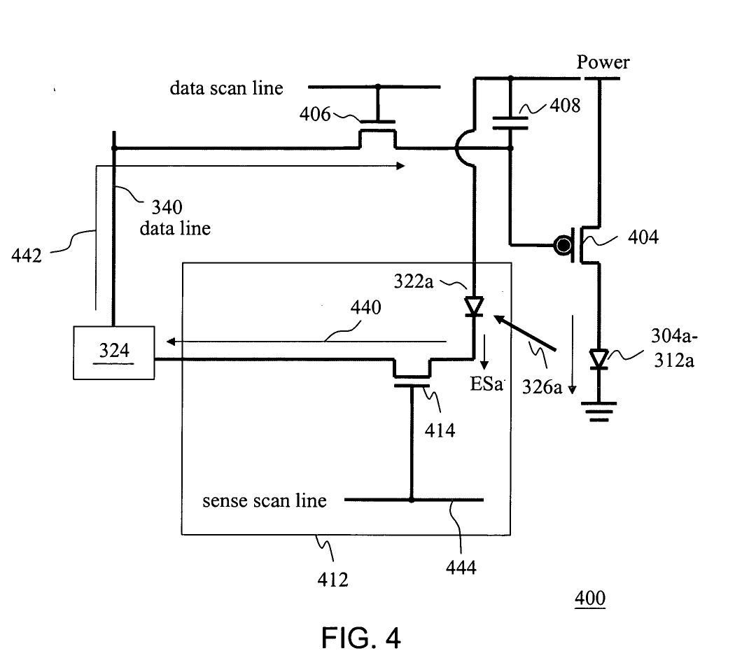

FIG. 5 is a plot of luminance versus gray scales of color lights emitted from a white light EL component according to one embodiment of the present invention. Referring to FIG. 5, the luminance of blue, green, red lights and the combined white light versus the gray scales are represented by curve 502a, 502b, 502c and 504 respectively. For example, the original luminance of the blue, green, red lights and the combined white light are Lb1, Lg1, Lr1 and Lwl respectively, wherein the curve 204 of the combined white light has a fixed CIE value defined by, for example, the ratio of Lb1, Lg1, and Lr1. In one embodiment of the present invention, the photo detectors 322a, 322b and 322c may detect luminance Lb1, Lg1, and Lr1 and output signals ESa1, ESb1 and ESc1.

Referring to FIG. 3A, for example, the light 326a (i.e., blue light) decays from Lb1 to Lb2 after working a period of time, the photo detectors 322a, 322b and 322c may detect luminance Lb2, Lg1, and Lr1 and output signals ESa2, ESb1 and ESc1 at this moment. Notably, ESa2 is less than ESa1 since the light 326a decays.

In one embodiment of the present invention, a data such as a predetermined ratio of the signals ESa/ESb/ESc detected by the photo detector 322a/322b/322c may be stored in the regulating device 324. In addition, a predetermined CIE value of a preset white light being a combination of the color lights 326a/326b/326c is stored in the regulating device 324. In one embodiment of the present invention, the predetermined ratio or CIE value may comprise a look-up table.

Therefore, as the signal ESa2 is received by the regulating device 324, the signal ESa2 is compared to the signal ESa1, wherein the difference Db between ESa2 and ESa1 is proportional to the difference between Lb2 and Lb1. Therefore, the regulating device 324 may generate regulating signal CSb according to the difference Db to reduce the light 326b from Lg1 to Lg2, and generate regulating signal CSc according to the difference Db to reduce the light 326c from Lr1 to Lr2. Accordingly, the luminance Lb2, Lg2 and Lr2 are less than Lb1, Lg1 and Lr1, but the CIE value of the white light (corresponding to the ratio of Lb2, Lg2 and Lr2) is equal to the predetermined CIE value (corresponding to the ratio of Lb1, Lg1 and Lr1). Accordingly, the CIE value of the white light may be maintained although the luminance of the white light may be reduced.

In other words, the electric signals ESa, ESb and ESc are received by the regulating device 324 and compared to the predetermined value stored in the regulating device 324 to decide a detected CIE value. When the detected CIE value is different from the predetermined CIE value, the signals applied to the EL pixels are adjusted to change the detected CIE value to fit the predetermined CIE value.

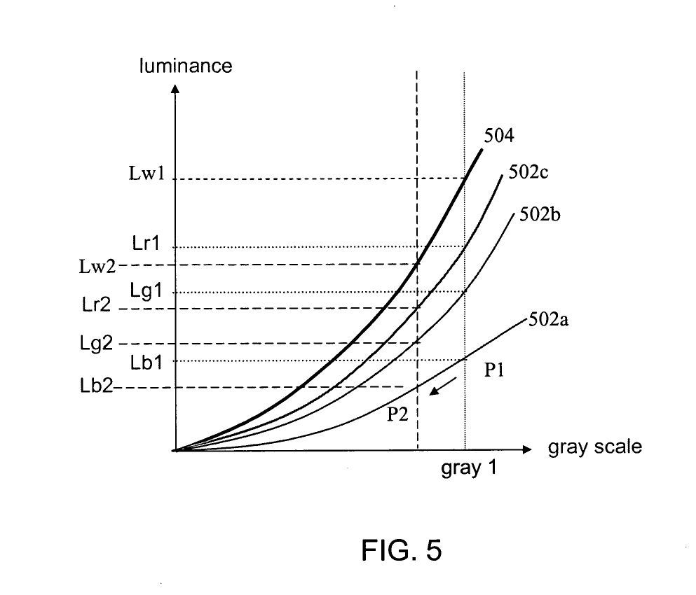

In one embodiment of the present invention, the photo detector may comprise photodiode or photo thin film transistor (TFT). FIG. 66A is a schematic cross-sectional view of a photodiode type photo detector according to one embodiment of the present invention. Referring to FIG. 6, a photodiode 622 may comprise a first conductive layer 624, a photosensitive layer 626, a P-type layer 628 and a second conductive layer 630. In one embodiment of the present invention, the first conductive layer 624 may comprise a metal layer, the photosensitive layer 626 may comprise an α-silicon layer, the P-type layer 628 may comprise a P-type α-silicon layer, and the second conductive layer 630 may comprise a metal layer or a transparent conductive layer such as indium tin oxide (ITO) or indium zinc oxide (IZO). When a light 642 passes through the photosensitive layer 626, the absorbed photo energy of the light 632 may be converted into the signal such as an induced current from the P-type layer 628 to the first conductive layer 624. In addition, the photodiode 622 may be formed over the substrate 602, and a cover layer 632 may be formed over the substrate 602 and covers the photodiode 622.

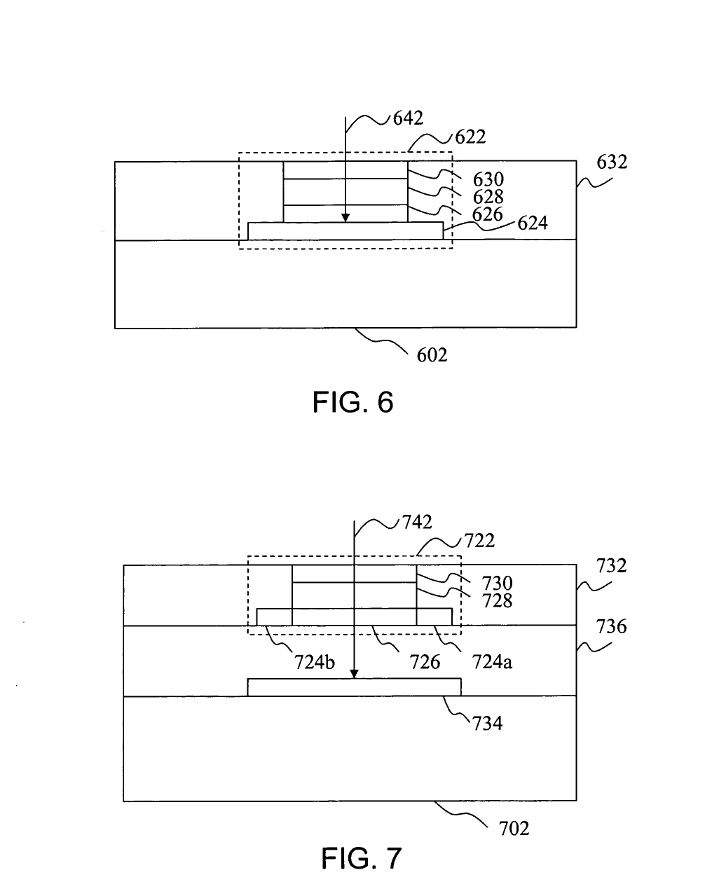

FIG. 7 is a schematic cross-sectional view of a photo TFT type photo detector according to one embodiment of the present invention. Referring to FIG. 7, a photo TFT 722 may comprise a source/drain region 724a/724b, a channel region 726, a photosensitive layer 728 and a gate layer 730. In one embodiment of the present invention, the gate layer 730 may comprise metal or transparent conductive layer such as indium tin oxide (ITO) or indium zinc oxide (IZO). When a light 742 passes through the photosensitive layer 728, the absorbed photo energy of the light 742 may be converted into signal such as an induced current through the channel region 726. The photo TFT 722 may be formed over the substrate 702, and a cover layer 732 may be formed over the substrate 702 and covers the photodiode 722. Furthermore, a light shielding layer 734 may also be formed between the substrate 702 and the photo TFT 722, and a cover layer 736 may be formed over the substrate 702 and covers the light shielding layer 734.

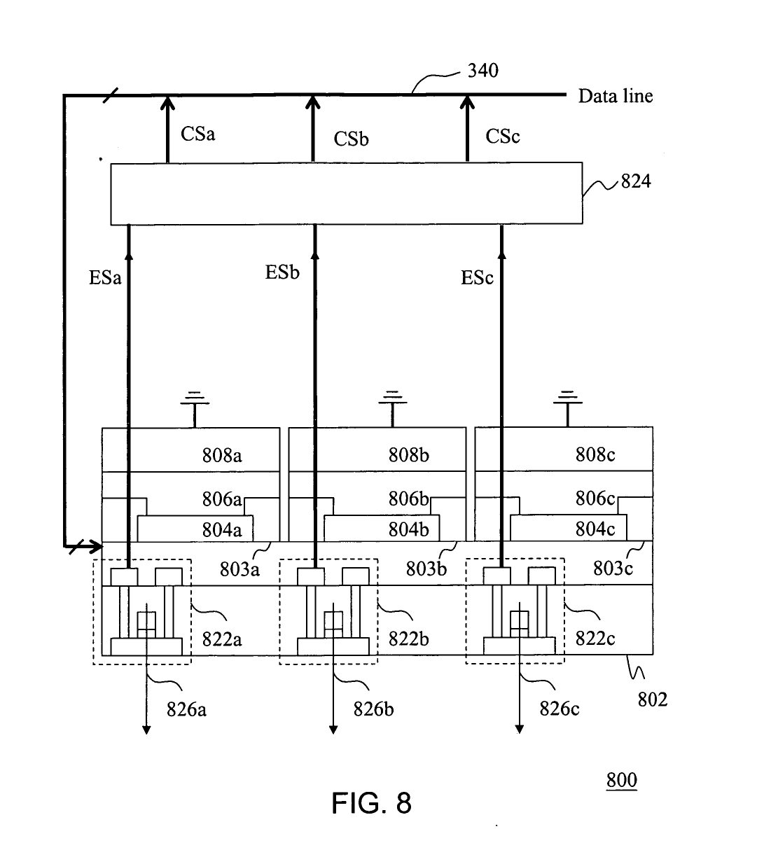

FIG. 8 is a schematic cross-sectional view illustrating a white light EL component according to another embodiment of the present invention. Referring to FIG. 8, the white light EL component 800 may comprise a transparent substrate 802, a first EL pixel 803a including a first photo detector 822a, a second EL pixel 803b including a second photo detector 822b, a third EL pixel 803c including a third photo detector 822c, and a regulating device 824. In one embodiment of the present invention, the first, second and third EL pixels may comprise blue, green and red EL pixels.

Referring to FIG. 8, the EL pixel 803a/803b/803c may comprise an anode layer 804a/804b/804c, a light emitting layer 806a/806b/806c, and a cathode layer 808a/808b/808c respectively. The driving mechanism is similar to FIG. 3A, wherein the EL pixels 803a/803b/803c are driven by the corresponding data signals from the data line 340. After the regulating device 824 receives the signals ESa/ESb/ESc, the proper regulating signals CSa/CSb/CSc are produced, and fed to the corresponding EL pixels to be regulated through the data line 340. In one embodiment of the present invention, the anode layer 804a, 804b or 804c may comprise indium tin oxide (ITO) or indium zinc oxide (IZO), and the cathode layer 808a, 808b or 808c may comprise metal. In addition, the material of the light emitting layer 806a, 806b or 806c may comprise organic light emitting diode (OLED) polymer material. In one embodiment of the present invention, the photo detector 822a/822b/822c may comprise photodiode as shown in FIG. 6 or photo thin film transistor (TFT) as shown in FIG. 7.

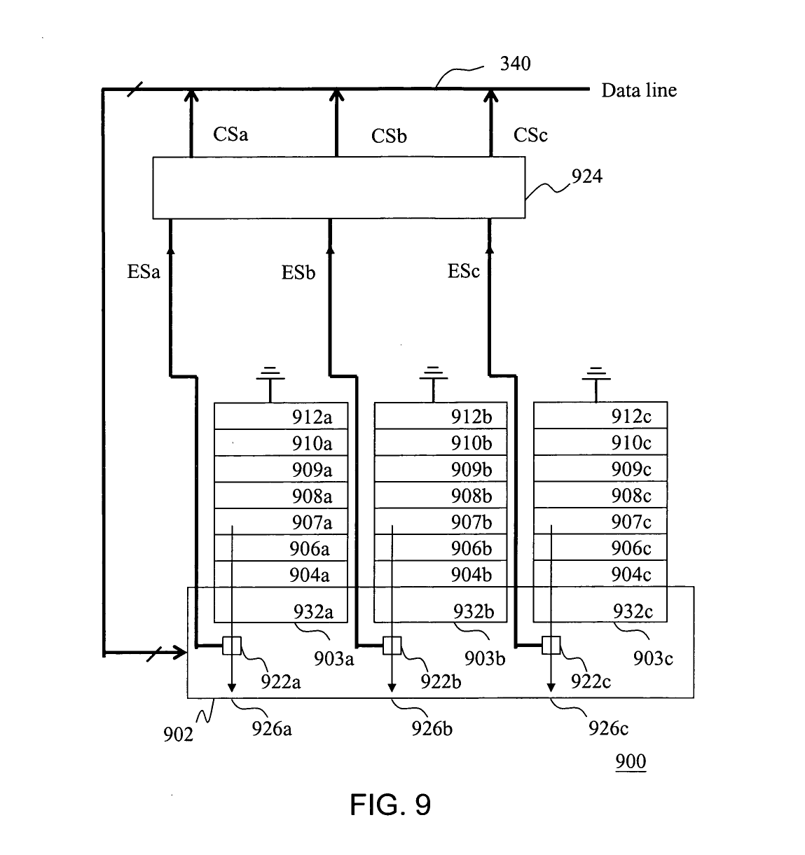

FIG. 9 is a schematic cross-sectional view illustrating a white light EL component according to another embodiment of the present invention. Referring to FIG. 9, the white light EL component 900 may comprise a transparent substrate 902, a first white EL pixel 903a including a first filter 932a and a first photo detector 922a, a second white EL pixel 903b including a second filter 932b and a second photo detector 922b, a third white EL pixel 903c including a third filter 932c and a third photo detector 922c, and a regulating device 924. In one embodiment of the present invention, the first, second and third filters may comprise blue, green and red filters. Therefore, the combined light emitted from the white light EL component 900 is white.

Referring to FIG. 9, the EL pixels 903a/903b/903c may comprise an anode layer 904a/904b/904c, a hole injection layer 906a/906b/906c, an NPB hole transport layer 907a/907b/907c, a yellow emitting layer 908a/908b/908c, a blue emitting layer 909a/909b/909c, an electron transport layer 910a/910b/910c, and a cathode layer 912a/912b/912c respectively. The driving mechanism is similar to FIG. 3A, wherein the EL pixels 903a/903b/903c are driven by the corresponding data signals from the data line 340. After the regulating device 924 receives the signals ESa/ESb/ESc, the proper regulating signals CSa/CSb/CSc are produced, and fed to the corresponding EL pixels to be regulated through the data line 340. In one embodiment of the present invention, the anode layer 904a, 904b or 904c may comprise indium tin oxide (ITO) or indium zinc oxide (IZO), and the cathode layer 912a, 912b or 912c may comprise metal. In addition, the material of the yellow or blue emitting layer 908a/908b/908c or 909a/909b/909c may comprise organic EL material or inorganic EL material. The organic EL material may comprise a small molecule organic EL material such as dye or pigment that may be formed by vacuum evaporation method, or a polymer organic EL material that may be formed by coating method.

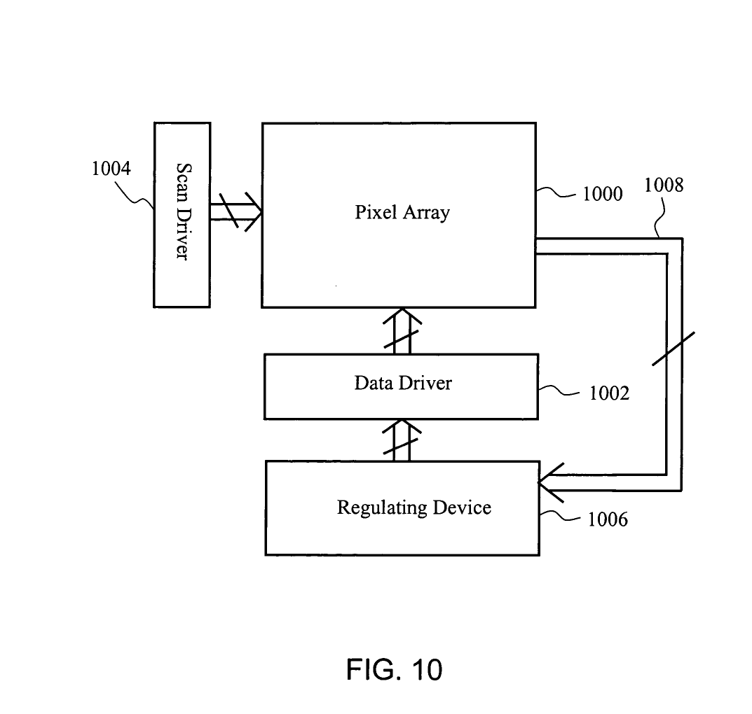

FIG. 10 is a drawing, schematically illustrating a layout of a displaying apparatus with the regulating device, according to the embodiment of the present invention. In FIG. 10, the relation between the regulating device 1006 and the array area 1000 are shown. In general, the pixels in the pixel array 1000 are driven by the scan driver 1004 and the data driver 1002. Then, under the design principle as described above, the regulating device 1006 can coupled with the data driver 1002. As a result in one example, the detected signals 1008, which can be, for example. ESa/ESb/ESc in FIG. 3A. The regulating signals CSa/CSb/CSc from the regulating device 1006 can also be transmitted through the data line in the data driver 1002 and reach any corresponding EL pixel, which is to be regulated, in the pixel array 1000.

In one embodiment of the present invention, the display panel comprises a liquid crystal display panel. In addition, the display device comprises a transmissive liquid crystal display device, a reflective liquid crystal display device or a transflective liquid crystal display device.

Accordingly, in the present invention, when the luminance efficiency of any one the light emitting layers decays, the decay of the corresponding signal may be detected by, for example, comparing the voltage value converted from the signals to the predetermined voltage value stored in the regulating device. Thereafter, the regulating device may output regulating signals to regulate the current signals on the EL pixels to obtain the white light. Accordingly, the CIE value of the combination of the lights may be fixed. In other words, the electric signals received by the regulating device are compared to the predetermined value stored in the regulating device to decide a detected CIE value. When the detected CIE value is different from the predetermined CIE value, the current values are adjusted to change the detected CIE value to fit the predetermined CIE value.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electroluminescent (EL) device, comprising:
a plurality of EL pixels, each emitting light; and
a photo detector associated with each EL pixel, detecting luminance of the light emitted by the associated EL pixel.

2. The EL device as in claim 1, further comprising a regulating device operatively coupled to the photo detectors of the EL pixels, adjusting luminance of at least another EL pixel based on detected luminance of one EL pixel.

3. The EL device as in claim 2, wherein each photo detector outputs a signal to the regulating device based on detected luminance of the associated EL pixel.

4. The EL device as in claim 3, wherein the signal represents voltage or current.

5. The EL device as in claim 2, wherein the regulating device maintains a predetermined relative luminance of the lights emitting from a group of the EL pixels, to maintain a predetermined set of CIE values of light of a particular color.

6. The EL device as in claim 5, wherein the particular color is white light.

7. The EL device of claim 1, wherein the EL pixels comprise a blue EL pixel, a green EL pixel and a red pixel.

8. The EL device of claim 7, wherein each EL pixel comprises OLED.

9. The EL device of claim 1, wherein the photo detector comprises a photodiode or a photo thin film transistor (TFT).

10. The EL device of claim 9, wherein the photo diode comprises:
a first conductive layer disposed over the transparent substrate;
a photosensitive layer disposed over the first conductive layer;
a P-type layer disposed over the first conductive layer; and
a second conductive layer disposed over the P-type layer.

11. The EL device of claim 9, wherein the photo TFT comprises:
a channel region disposed over the transparent substrate;
a source/drain region disposed beside the channel region and over the transparent substrate;
a photosensitive layer disposed over the channel region; and
a gate layer disposed over the photosensitive layer.

12. The EL device of claim 1, wherein a material of the light emitting layer comprises an organic EL material or an inorganic EL material.

13. The EL device of claim 1, wherein each EL pixel comprises a color filter.

14. The EL device of claim 13, wherein the color filter comprise a blue color filter, a green color filter or a red color filter.

15. The EL device of claim 1, wherein each EL pixel further comprises a yellow emitting layer and a blue emitting layer.

16. A method for driving a plurality of EL pixels in an EL device, comprising:
driving the EL pixels to emit light;
providing a photo detector associated with each EL pixel;
detecting luminance of the light emitted by the associated EL pixel; and
adjusting luminance of at least another EL pixel based on the detected luminance of the associated EL pixel.

17. The method as in claim 16, wherein the adjusting step comprises maintaining a predetermined relative luminance of the lights emitting from a group of the EL pixels, to maintain a predetermined set of CIE values of light of a particular color.

18. The method as in claim 16, wherein the particular color is white light.
